(19) United States
(12) Patent Application Publication
(10) Pub. No.: US 2025/0365538 A1
(43) Pub. Date: Nov. 27, 2025

(54) Audio Processing Method, Audio Processing Apparatus, and Non-Transitory Computer-Readable Storage Medium

(71) Applicant: Yamaha Corporation, Hamamatsu-shi (JP)

(72) Inventor: Hitoshi AKIYAMA, Hamamatsu (JP)

(21) Appl. No.: 19/294,588

(22) Filed: Aug. 8, 2025

Related U.S. Application Data
(63) Continuation of application No. PCT/JP2024/002384, filed on Jan. 26, 2024.

(30) Foreign Application Priority Data
Feb. 10, 2023 (JP) 2023-019095

(51) Int. Cl. H04R 3/04

(52) U.S. Cl. CPC H04R 3/04; H04R 2430/03

(57) ABSTRACT

A sound processing method includes receiving, as an input, a first sound signal sampled at a first sampling frequency. The sound processing method also includes generating, as an output, a second sound signal that is based on aliasing noise for the first sound signal from a frequency range that is higher than a first Nyquist frequency of the first sound signal, using a trained model, in order to produce a third sound signal with a frequency component higher than the first Nyquist frequency. The sound processing method also includes mixing the first sound signal and the third sound signal to create a fourth sound signal.

### CROSS-REFERENCE TO RELATED APPLICATIONS

The present application is a continuation application of International Application No. PCT/JP2024/002384, filed Jan. 26, 2024, which claims priority to Japanese Patent Application No. 2023-019095, filed Feb. 10, 2023. The contents of these applications are incorporated herein by reference in their entirety.

### BACKGROUND

The present disclosure relates to a sound processing method, a sound processing apparatus, and a non-transitory computer-readable storage medium.

JP 6425097 B2 discloses a high-frequency signal generation circuit 26 that uses: (i) a plurality of low-frequency sub-band signals fed from a low-frequency sampling bandpass filter unit 23; and (ii) a plurality of high-frequency sub-band power estimates fed from a high-frequency sub-band power estimation circuit 25, to create high-frequency signals that form signal components at higher frequencies and feed the same to a high-pass filter 27.

High-frequency components created by conventional bandwidth extension techniques may not be physically correct.

An object of the present disclosure is, in one aspect, to provide a sound processing method that can create physically correct high-frequency components.

### SUMMARY

One aspect is a sound processing method that includes receiving, as an input, a first sound signal sampled at a first sampling frequency. The sound processing method also includes generating, as an output, a second sound signal that is based on aliasing noise for the first sound signal from a frequency range that is higher than a first Nyquist frequency of the first sound signal, using a trained model, in order to produce a third sound signal with a frequency component higher than the first Nyquist frequency. The sound processing method also includes mixing the first sound signal and the third sound signal to create a fourth sound signal.

Another aspect is a sound processing apparatus that includes a processor and a memory. The memory stores instructions that, when executed by the processor, cause the processor to carry out receiving, as an input, a first sound signal sampled at a first sampling frequency. The instructions, when executed by the processor, also cause the processor to carry out generating, as an output, a second sound signal that is based on aliasing noise for the first sound signal from a frequency range that is higher than a first Nyquist frequency of the first sound signal, using a trained model, in order to produce a third sound signal with a frequency component higher than the first Nyquist frequency. The instructions, when executed by the processor, also cause the processor to carry out mixing the first sound signal and the third sound signal to create a fourth sound signal.

Another aspect is a non-transitory computer-readable storage medium that stores a sound processing program executable by at least one processor to execute receiving, as an input, a first sound signal sampled at a first sampling frequency. The at least one processor also executes the sound processing program to execute generating, as an output, a second sound signal that is based on aliasing noise for the first sound signal from a frequency range that is higher than a first Nyquist frequency of the first sound signal, using a trained model, in order to produce a third sound signal with a frequency component higher than the first Nyquist frequency. The at least one processor also executes the sound processing program to execute mixing the first sound signal and the third sound signal to create a fourth sound signal.

The embodiments can create high-frequency components that are physically correct.

A more complete appreciation of the present disclosure and many of the attendant advantages thereof will be readily obtained as the same becomes better understood by reference to the following detailed description when considered in connection with the following figures.

### BRIEF DESCRIPTION OF THE DRAWINGS

FIG. 1 is a block diagram illustrating the configuration of a sound processing apparatus, in accordance with embodiments of the present disclosure;

FIG. 2 is a functional block diagram of a sound processing program that may be implemented by a processor, in accordance with embodiments of the present disclosure;

FIG. 3 is a flowchart of the operation of the sound processing program;

FIG. 4 is a functional block diagram of the sound processing program during a training step to prepare a trained model; and

FIG. 5 is a flowchart of how the sound processing program works in the training step to prepare the trained model.

### DETAILED DESCRIPTION

The present specification is applicable to a sound processing method, a sound processing apparatus, and a non-transitory computer-readable storage medium.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure.

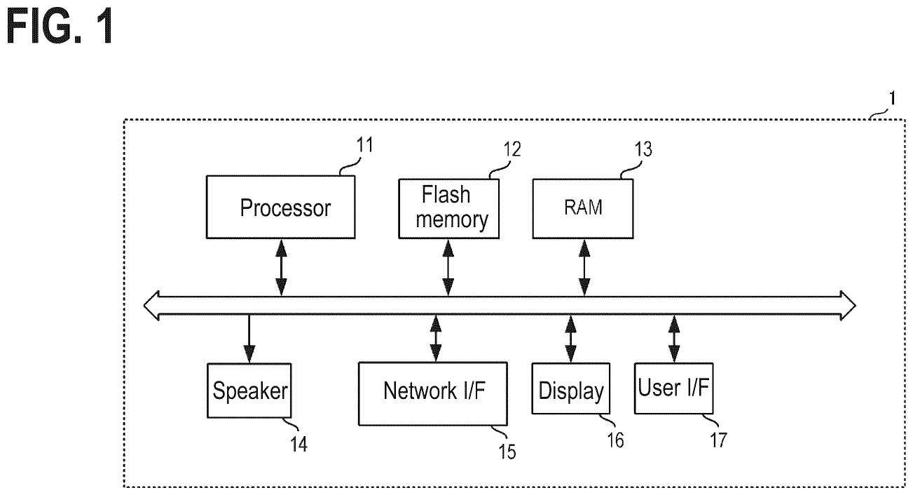

FIG. 1 is a block diagram illustrating the configuration of a sound processing apparatus 1, in accordance with embodiments of the present disclosure.

The sound processing apparatus 1 includes a processor 11, a flash memory 12, a random access memory (or RAM) 13, a speaker 14, a network interface (or network I/F) 15, a display 16, and a user interface (or user I/F) 17.

The sound processing apparatus 1 can be, for example, a smartphone, a personal computer, a set-top box, a sound receiver, or any other such information processing device. For instance, the sound processing apparatus 1 receives content data from a server or some other source over the Internet. The sound processing apparatus 1 decodes the received content data to retrieve sound signals. The content data may be stored in the flash memory 12 of the apparatus.

The processor 11 can include a CPU, a DSP, a system-on-a-chip (or SOC), or any other such element and load into the RAM 13 a program stored in the flash memory 12, which serves as a storage medium, so that prescribed functions are ready to be executed. For instance, the flash memory 12 stores a sound processing program. In embodiments, the processor 11 runs the program to execute a sound processing method.

The network I/F 15 is a wireless communication unit in compliance with Wi-Fi (registered trademark), Bluetooth (registered trademark), or any other such protocol, for example. The network I/F 15 wirelessly communicates with the server or some other source to receive the content data.

The processor 11 retrieves the sound signals from the content data received via the network I/F 15. The processor 11 subjects the retrieved sound signals to filtering and feeds the resultant to the speaker 14 that includes a digital-to-analog converter (or D/A converter) and an amplifier. The speaker 14 generates sound in accordance with the sound signals fed from the processor 11.

The display 16 can include a LCD, an OLED, or any other such display element, for example. The user I/F 17 can include a touch panel, a mouse, a keyboard, or any other such input device, for example.

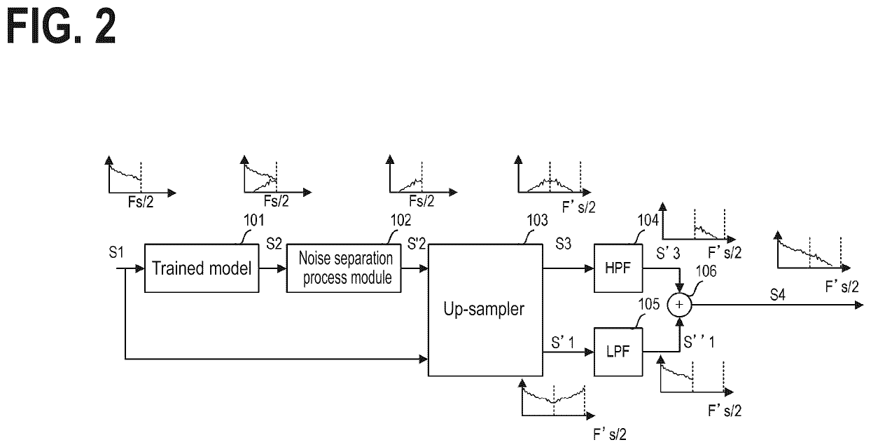

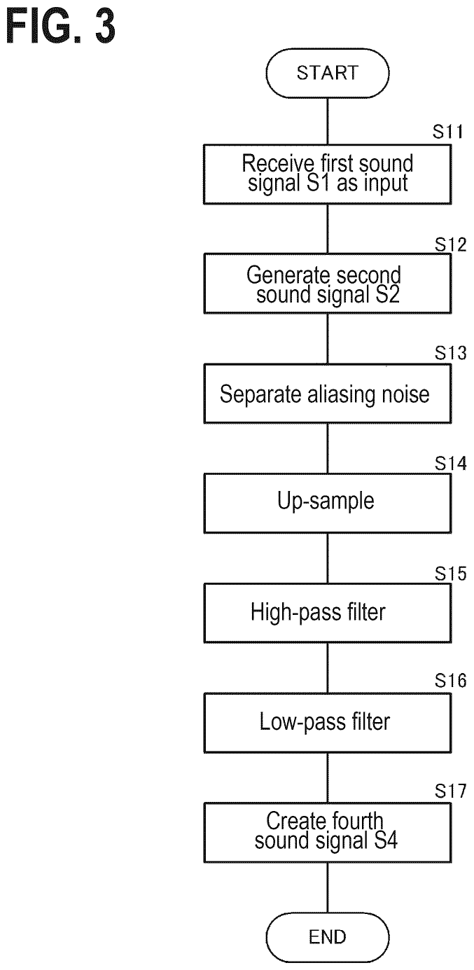

FIG. 2 is a functional block diagram of the sound processing program that may be implemented by the processor 11. FIG. 3 is a flowchart of the operation of the sound processing program. The sound processing program implements a trained model 101, a noise separation process module 102, an up-sampler 103, a high-pass filter (or HPF) 104, a low-pass filter (or LPF) 105, and an adder 106.

During the execution phase, the trained model 101 receives, as an input, a first sound signal S1 sampled at a first sampling frequency Fs (for example, at 48 kHz) (at step S11) and generates a second sound signal S2 (at step S12). The trained model 101 is trained to generate, as an output, the second sound signal S2 that is based on aliasing noise for the first sound signal S1 from a frequency range that is higher than the first Nyquist frequency Fs/2 of the first sound signal S1. For instance, the second sound signal S2 that is based on aliasing noise corresponds to a combination of the first sound signal S1 and the aliasing noise. Moreover, the second sound signal S2 may be subjected to a separation process in which the first sound signal S1 is subtracted from the second sound signal S2 for separation of a component that thereby forms a difference between the signals.

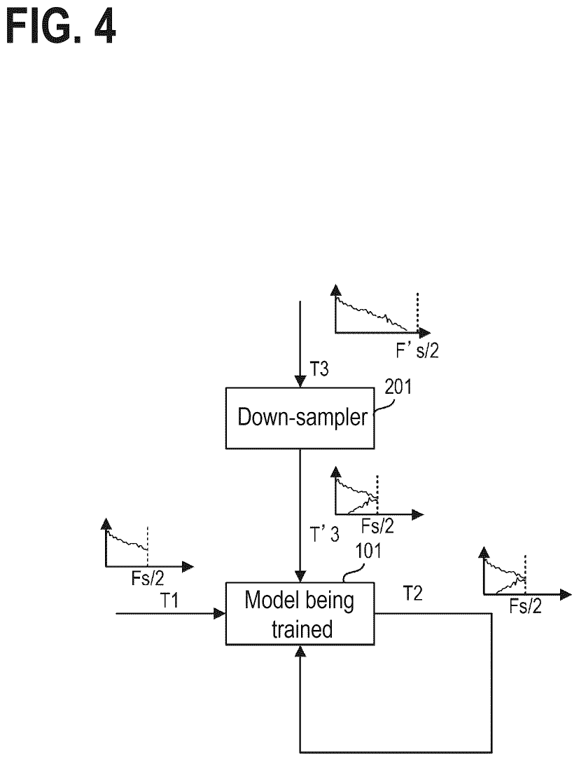

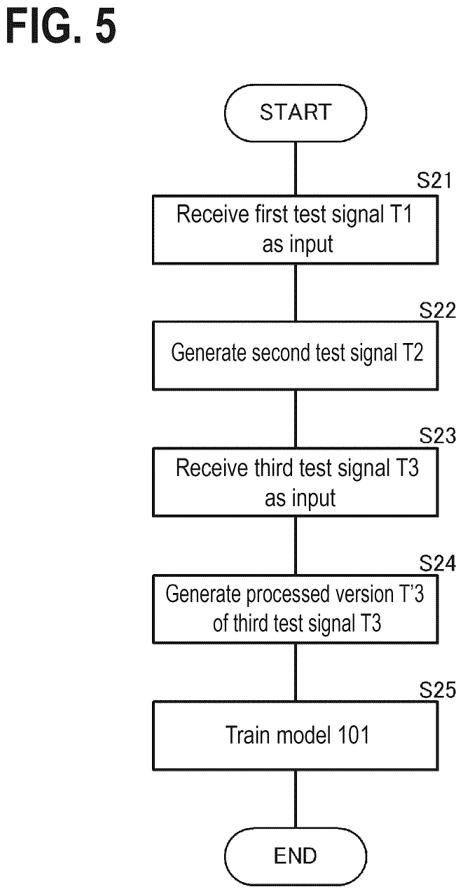

FIG. 4 is a functional block diagram of the sound processing program during a training step to prepare the trained model 101. FIG. 5 is a flowchart of how the sound processing program works in the training step to prepare the trained model 101. During the training step, the sound processing program implements a model 101 subjected to training and a down-sampler 201.

The model 101 subjected to training receives, as an input, a first test signal T1 that is used for training purposes and sampled at the first sampling frequency Fs (at step S21). The first test signal T1 may be any type of signal such as, for example, a sound signal for music content.

Then, the model 101 subjected to training generates a second test signal T2 that corresponds to a combination of the first test signal T1 and aliasing noise for the first test signal T1 from a frequency range that is higher than the first Nyquist frequency Fs/2 (at step S22).

The down-sampler 201 receives, as an input, a third test signal T3 that is sampled at a second sampling frequency F′s (for example, at 96 kHz) (at step S23). Both the third test signal T3 and the first test signal T1 are sound signals for the same piece of music content, but differ in that the third test signal T3 is sampled at the second sampling frequency F′s. The down-sampler 201 down-samples the third test signal T3 to the first sampling frequency Fs. In this process, a processed version T′3 of the third test signal T3 is generated in which a component of the third test signal T3 that is higher than the first Nyquist frequency Fs/2 has been folded onto the rest of the third test signal T3 as aliasing noise (at step S24).

The sound processing program includes a prescribed algorithm that is used to train the model 101 to minimize the error between the second test signal T2 and the processed version T′3 of the third test signal T3. The training results in the second test signal T2 more approximately representing the processed version T′3 of the third test signal T3. As previously described, both the third test signal T3 and the first test signal T1 are sound signals for the same piece of music content. Hence, the model 101 can be trained to generate a sound signal corresponding to a combination of an input sound signal and aliasing noise that represents a physically correct high-frequency component for the input sound signal. In other words, the trained model 101 serves as a filter whose input receives an input sound signal and whose output produces a signal corresponding to a combination of the input sound signal and aliasing noise for the input sound signal from a frequency range that is higher than the first Nyquist frequency Fs/2.

It is to be noted that the algorithm that can be used in embodiments to train the model 101 include, but is not limited to, a convolutional neural network (or CNN), a recurrent neural network (or RNN), or any other such machine training algorithm.

Referring back to FIG. 3, the noise separation process module 102 implemented by the sound processing program separates the aliasing noise from the second sound signal S2 that is output from the trained model 101 (at step S13). The noise separation process may use any type of processing technique, and can be carried out using a spectral subtraction technique, a Wiener filtering technique, a model-based technique, or any other such technique, for example. A model-based noise separation process can involve receiving, as an input, the second sound signal S2 and generating, as an output, the separated aliasing noise, by a second trained model.

In this way, the noise separation process module 102 generates a processed version S′2 of the second sound signal S2, namely, an aliasing noise component for the first sound signal S1.

The up-sampler 103 receives, as inputs, the first sound signal S1 and the processed version S′2 of the second sound signal S2 and up-samples each of the signals to the second sampling frequency F′s (at 96 kHz) such that the frequency characteristics of the resulting signals are symmetrical with respect to the first Nyquist frequency Fs/2 (at step S14). In other words, the up-sampler 103 produces an up-sampled version S′1 of the first sound signal S1 and a third sound signal S3 that is an up-sampled version of the processed version S′2 of the second sound signal S2. Thus, the processed version S′2 of the second sound signal S2—that is, the aliasing noise—is transformed to the third sound signal S3 that contains a frequency component that is higher than the first Nyquist frequency Fs/2.

The HPF104 high-pass filters the third sound signal S3 to remove one or more components equal to or lower than the first Nyquist frequency Fs/2 from the third sound signal S3 (at step S15). The LPF 105 low-pass filters the up-sampled version S′1 of the first sound signal S1 to remove one or more components higher than the first Nyquist frequency Fs/2 from the up-sampled version S′1 of the first sound signal S1 (at step S16). The high-pass filtered version of the third sound signal S3 only contains a component that is higher than the first Nyquist frequency Fs/2 and equal to or lower than a second Nyquist frequency F′s/2. After being low-pass filtered, the up-sampled version S′1 of the first sound signal S1 only contains a component that is equal to or lower than the first Nyquist frequency Fs/2.

The adder 106 mixes the low-pass filtered, up-sampled version S″1 of the first sound signal S1 and the high-pass filtered version S′3 of the third sound signal S3 to create a fourth sound signal S4 (at step S17). In this way, the sound processing program in embodiments can create a fourth sound signal that contains a component equal to or lower than the second Nyquist frequency F′s/2.

The sound processing program in embodiments makes use of a trained model 101 that is trained to generate, as an output, the second sound signal S2 that is based on aliasing noise for the first sound signal S1 from a frequency range that is higher than the first Nyquist frequency Fs/2 of the first sound signal S1. Since the trained model 101 is trained using sound signals for the same piece of music content with one of them being a sound signal without aliasing noise and the other of them being a sound signal with aliasing noise, the trained model 101 can reproduce aliasing noise that represents physically correct high-frequency components for an input sound signal. Therefore, a user can enjoy the customer experience of being able to listen to high quality sound having high-frequency components that are physically correct.

It should be noted that, while the above-described example presented an example value of 48 kHz for the first sampling frequency Fs and an example value of 96 kHz for the second sampling frequency F′s, other example values are also possible; for instance, 44.1 kHz for the first sampling frequency Fs and 88.2 kHz for the second sampling frequency F′s. In certain embodiments, the sound processing program may up-sample the fourth sound signal at the second sampling frequency F′s of 88.2 kHz to a higher frequency of 96 KHz. In different embodiments, the sound processing program may up-sample a sound signal at the first sampling frequency Fs of 44.1 kHz to a higher frequency of 48 kHz to use the up-sampled version of the sound signal at 48 kHz as the first sound signal S1 that, in turn, is input to the trained model 101.

Further, any sound signal with any type of compression and encoding may be used as the input sound signal. When a compressed and encoded sound signal is to be used as an input, the sound processing program may decode the sound signal into an uncompressed form to use the uncompressed form as the input first sound signal S1. In alternative embodiments, the model 101 may be trained by using a compressed and encoded sound signal for a certain piece of music content as well as another input sound signal that is uncompressed and provided with aliasing noise for the same piece of music content. The sound processing program in this scenario can also reproduce aliasing noise that represents physically correct high-frequency components for an input sound signal.

In the above-described example, the trained model 101 is trained to output, as the second sound signal, a signal corresponding to a combination of the first sound signal and aliasing noise for the first sound signal. In alternative embodiments, the model 101 may be trained to output, as the second sound signal, the aliasing noise alone. In this scenario, the noise separation process module 102 can be omitted. In different embodiments, the model 101 may be trained to output an aliasing noise-based, sound signal at the second sampling frequency F′s that only contains a frequency component that is higher than the first Nyquist frequency Fs/2. In this scenario, the noise separation process module 102 and the HPF 104 can be omitted.

The program may be provided in the form of a computer-readable storage medium and installed on a computer. An example of the storage medium is a non-transitory storage medium. A preferred example is an optical storage medium (or optical disc) such as a CD-ROM. Another possible example is any other known form of storage medium such as a semiconductor storage medium and a magnetic storage medium. It is to be noted that a non-transitory storage medium according to the present disclosure encompasses any form of storage medium excluding a transitory propagating signal. A volatile storage medium is encompassed within the non-transitory storage medium. The program may be distributed from a distribution device over a communication network. In this case, a storage medium that stores the program in the distribution device corresponds to the non-transitory storage medium.

The foregoing description of embodiments should be considered illustrative and not restrictive in all respects, and the scope of the present invention is to be defined not by the embodiments described herein but by the following claims. Moreover, the scope of the present invention shall encompass all that would come within the meaning of equivalency of the claims.

What is claimed is:

1. A sound processing method comprising:
receiving, as an input, a first sound signal sampled at a first sampling frequency;
generating, as an output, a second sound signal that is based on aliasing noise for the first sound signal from a frequency range that is higher than a first Nyquist frequency of the first sound signal, using a trained model, in order to produce a third sound signal with a frequency component higher than the first Nyquist frequency; and
mixing the first sound signal and the third sound signal to create a fourth sound signal.

2. The sound processing method according to claim 1, wherein:
the trained model is trained to output, as the second sound signal, a signal corresponding to a combination of the first sound signal and the aliasing noise, and
the sound processing method further comprises:
separating the aliasing noise from the second sound signal to use the separated aliasing noise to produce the third sound signal.

3. The sound processing method according to claim 2, further comprising:
up-sampling the first sound signal to a second sampling frequency higher than the first sampling frequency; and
up-sampling the separated aliasing noise to the second sampling frequency to produce the third sound signal,
wherein the mixing comprises mixing the first sound signal after being up-sampled to the second sampling frequency and the third sound signal, to create the fourth sound signal.

4. The sound processing method according to claim 3, further comprising:
low-pass filtering the first sound signal after being up-sampled to the second sampling frequency, to remove a component higher than the first Nyquist frequency from the first sound signal; and
high-pass filtering the third sound signal produced through the up-sampling to the second sampling frequency, to remove a component equal to or lower than the first Nyquist frequency from the third sound signal,
wherein the mixing comprises mixing the first sound signal after being low-pass filtered and the third sound signal after being high-pass filtered.

5. The sound processing method according to claim 2, wherein the separating is carried out based on a spectral subtraction technique.

6. The sound processing method according to claim 2, wherein the separating comprises receiving, as an input, the second sound signal, and generating, as an output, the separated aliasing noise using a second trained model.

7. The sound processing method according to claim 2, wherein the separating is carried out based on a difference between the first sound signal and the second sound signal.

8. A sound processing apparatus comprising:
a processor; and
a memory storing instructions that, when executed by the processor, cause the processor to carry out:
receiving, as an input, a first sound signal sampled at a first sampling frequency;
generating, as an output, a second sound signal that is based on aliasing noise for the first sound signal from a frequency range that is higher than a first Nyquist frequency of the first sound signal, using a trained model, in order to produce a third sound signal with a frequency component higher than the first Nyquist frequency; and
mixing the first sound signal and the third sound signal to create a fourth sound signal.

9. The sound processing apparatus according to claim 8, wherein:
the trained model is trained to output, as the second sound signal, a signal corresponding to a combination of the first sound signal and the aliasing noise; and
the instructions cause the processor to carry out:
separating the aliasing noise from the second sound signal to use the separated aliasing noise to produce the third sound signal.

10. The sound processing apparatus according to claim 9, wherein:
the instructions cause the processor to carry out:
up-sampling the first sound signal to a second sampling frequency higher than the first sampling frequency; and
up-sampling the separated aliasing noise to the second sampling frequency to produce the third sound signal; and
the mixing comprises mixing the first sound signal after being up-sampled to the second sampling frequency and the third sound signal, to create the fourth sound signal.

11. The sound processing apparatus according to claim 10, wherein:
the instructions cause the processor to carry out:
low-pass filtering the first sound signal after being up-sampled to the second sampling frequency, to remove a component higher than the first Nyquist frequency from the first sound signal; and
high-pass filtering the third sound signal produced through the up-sampling to the second sampling frequency, to remove a component equal to or lower than the first Nyquist frequency from the third sound signal; and
the mixing comprises mixing the first sound signal after being low-pass filtered and the third sound signal after being high-pass filtered.

12. The sound processing apparatus according to claim 9, wherein the separating is carried out based on a spectral subtraction technique.

13. The sound processing apparatus according to claim 9, wherein the separating comprises receiving, as an input, the second sound signal, and generating, as an output, the separated aliasing noise using a second trained model.

14. The sound processing apparatus according to claim 9, wherein the separating is carried out based on a difference between the first sound signal and the second sound signal.

15. A non-transitory computer-readable storage medium storing a sound processing program executable by at least one processor, that when executed by the at least one processor, causes the at least one processor to execute a method comprising:
receiving, as an input, a first sound signal sampled at a first sampling frequency;
generating, as an output, a second sound signal that is based on aliasing noise for the first sound signal from a frequency range that is higher than a first Nyquist frequency of the first sound signal, using a trained model, in order to produce a third sound signal with a frequency component higher than the first Nyquist frequency; and
mixing the first sound signal and the third sound signal to create a fourth sound signal.

16. The non-transitory computer-readable storage medium according to claim 15, wherein:
the trained model is trained to output, as the second sound signal, a signal corresponding to a combination of the first sound signal and the aliasing noise; and
the method further comprises:
separating the aliasing noise from the second sound signal to use the separated aliasing noise to produce the third sound signal.

17. The non-transitory computer-readable storage medium according to claim 16, wherein:
the method further comprises:
up-sampling the first sound signal to a second sampling frequency higher than the first sampling frequency; and
up-sampling the separated aliasing noise to the second sampling frequency to produce the third sound signal; and
the mixing comprises mixing the first sound signal after being up-sampled to the second sampling frequency and the third sound signal, to create the fourth sound signal.

18. The non-transitory computer-readable storage medium according to claim 17, wherein:
the method further comprises:
low-pass filtering the first sound signal after being up-sampled to the second sampling frequency, to remove a component higher than the first Nyquist frequency from the first sound signal; and
high-pass filtering the third sound signal produced through the up-sampling to the second sampling frequency, to remove a component equal to or lower than the first Nyquist frequency from the third sound signal; and
the mixing comprises mixing the first sound signal after being low-pass filtered and the third sound signal after being high-pass filtered.

19. The non-transitory computer-readable storage medium according to claim 16, wherein the separating is carried out based on a spectral subtraction technique.

20. The non-transitory computer-readable storage medium according to claim 16, wherein the separating comprises receiving, as an input, the second sound signal, and generating, as an output, the separated aliasing noise using a second trained model.
